(19) United States
(12) Patent Application Publication
(10) Pub. No.: US 2026/0093919 A1
(43) Pub. Date: Apr. 2, 2026

(54) END OF SENTENCE DETECTION WITH SENTENCE LENGTH-BASED PENALTY AND GRAMMATICAL VOICE-BASED DATA AUGMENTATION AND INFERENCE TIME TOKEN MERGING

(71) Applicant: Samsung Electronics Co., Ltd., Suwon-si (KR)

(72) Inventors: Saket Gurukar, Irvine, CA (US); Eduardo Rivas Posada, Monterrey (MX); Yoshio Josue Rubio Higuera, Tijuana (MX); Asim Kadav, Mountain View, CA (US)

(21) Appl. No.: 19/047,106

(22) Filed: Feb. 6, 2025

Related U.S. Application Data
(60) Provisional application No. 63/700,284, filed on Sep. 27, 2024.

(51) Int. Cl. G06F 40/284; G06F 40/30; G06F 40/58

(52) U.S. Cl. CPC G06F 40/284; G06F 40/30; G06F 40/58

(57) ABSTRACT

A method includes receiving a first sequence of text comprising a part of a sentence, providing the first sequence of text to a first artificial intelligence (AI) model to obtain an output, and predicting an end-of-sentence (EOS) based on the output. The method includes determining, based on the predicted EOS if the first sequence of text comprises a complete sentence, responsive to determining that the first sequence of text comprises the complete sentence, providing text within the first sequence of text comprising the complete sentence as an input to a second AI model and responsive to determining that the first sequence of text does not comprise the complete sentence, receiving a second sequence of text. The first AI model is optimized based on a sentence length-based loss function.

### CROSS-REFERENCE TO RELATED APPLICATIONS AND PRIORITY CLAIM

This application claims priority under 35 U.S.C. § 119(e) to U.S. Provisional Patent Application No. 63/700,284 filed Sep. 27, 2024, which is hereby incorporated by reference in its entirety.

### TECHNICAL FIELD

This disclosure relates generally to artificial intelligence and machine learning (AI/ML) based processing of textual inputs. More specifically, the present disclosure relates to end of sentence detection with sentence length-based penalties, grammatical voice-based data augmentation, and inference time token merging.

### BACKGROUND

Improvements in large language models (LLMs) and other AI/ML based tools have expanded many devices' capacity to use natural language textual inputs. These improvements have enabled devices such as televisions, smartphones, and internet of things (IoT) apparatus, which have less computational processing power than, for example, desktop computers or cloud computing platforms, to locally implement (i.e., without the assistance of a server or more powerful networked device) on-device AI/ML language processing models for a variety of applications. Examples of such locally-implemented on-device AI/ML language processing models include, without limitation, models for on-device, real-time translation of text (for example, subtitles or voice commands) into a second language.

In contrast to larger, deeper AI/ML language processing models implemented at servers or more powerful processing devices, lightweight, on-device AI/ML language processing models can be more sensitive to syntactical errors in their inputs. Specifically, providing on-device AI/ML language processing models with inputs containing syntactic errors such as incomplete sentences, or incorrectly split compound words (for example, “with draw” instead of “withdraw”) can significantly degrade performance.

### SUMMARY

This disclosure relates to end of sentence (EOS) detection, training EOS models with a sentence length-based loss function, grammatical voice-based data augmentation, and inference time token merging.

In a first embodiment, a method includes receiving a first sequence of text comprising a part of a sentence, providing the first sequence of text to a first artificial intelligence (AI) model to obtain an output, and predicting an end-of-sentence (EOS) based on the output. The method includes determining, based on the predicted EOS if the first sequence of text comprises a complete sentence, responsive to determining that the first sequence of text comprises the complete sentence, providing text within the first sequence of text comprising the complete sentence as an input to a second AI model and responsive to determining that the first sequence of text does not comprise the complete sentence, receiving a second sequence of text. The first AI model is optimized based on a sentence length-based loss function.

In a second embodiment, an electronic device includes a memory and at least one processor. The at least one processor can be configured to receive a first sequence of text comprising a part of a sentence, provide the first sequence of text to a first artificial intelligence (AI) model to obtain an output, and predicting an end-of-sentence (EOS) based on the output. The at least one processor can be configured to determine, based on the predicted EOS if the first sequence of text comprises a complete sentence, responsive to determining that the first sequence of text comprises the complete sentence, provide text within the first sequence of text comprising the complete sentence as an input to a second AI model, and responsive to determining that the first sequence of text does not comprise the complete sentence, receive a second sequence of text. The first AI model can be optimized based on a sentence length-based loss function.

In a third embodiment, a non-transitory computer-readable medium includes instructions, which, when executed by at least one processor, cause an electronic device to receive a first sequence of text comprising a part of a sentence. The non-transitory computer-readable medium further includes instructions, which, when executed by the at least one processor, cause the electronic device to provide the first sequence of text to a first artificial intelligence (AI) model to obtain an output, and predicting an end-of-sentence (EOS) based on the output. The non-transitory computer-readable medium further includes instructions, which, when executed by the at least one processor, cause the electronic device to determine, based on the predicted EOS if the first sequence of text comprises a complete sentence. The non-transitory computer-readable medium further includes instructions, which, when executed by the at least one processor, cause the electronic device to responsive to determining that the first sequence of text comprises the complete sentence, provide text within the first sequence of text comprising the complete sentence as an input to a second AI model. The non-transitory computer-readable medium further includes instructions, which, when executed by the at least one processor, cause the electronic device to responsive to determining that the first sequence of text does not comprise the complete sentence, receive a second sequence of text. The first AI model is optimized based on a sentence length-based loss function.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include any other electronic devices now known or later developed.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which:

FIG. 1 illustrates an example network configuration including an electronic device in accordance with this disclosure;

FIG. 2 illustrates an example of a training pipeline for an end of sentence (EOS) model in accordance with this disclosure;

FIG. 3 illustrates a skew in distributions of sentence lengths between ground truth values and predicted values which can be mitigated by training an EOS model in accordance with this disclosure;

FIGS. 4A and 4B illustrate implementations of on-device EOS inference in accordance with this disclosure; and

FIG. 5 illustrates operations of an example method for performing EOS detection in accordance with this disclosure.

### DETAILED DESCRIPTION

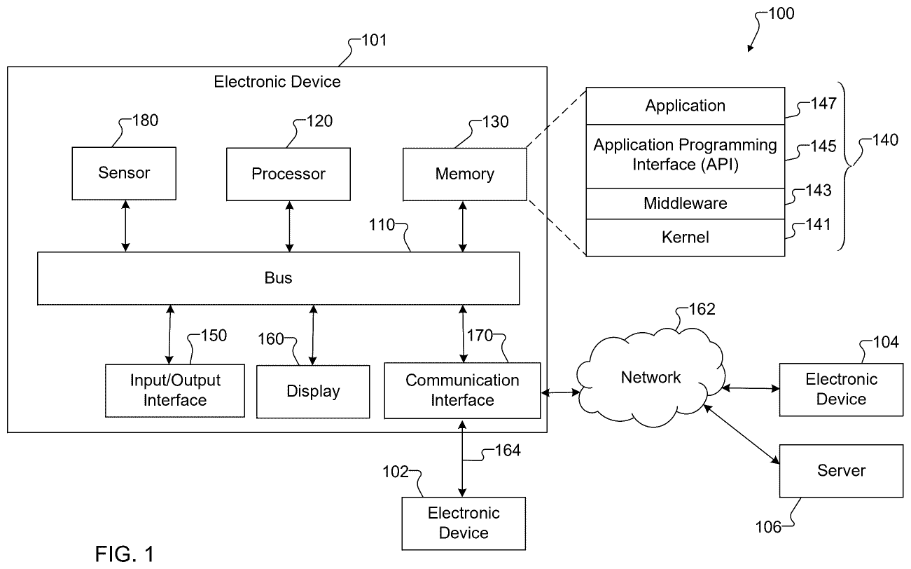

FIGS. 1 through 5, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, on-device AI/ML language processing models implemented by the processing devices of televisions, smartphones, and other apparatus, which, due to one or more of their size, dependence on battery power, or intended function, possess less processing power than dedicated processing devices (such as laptop or server computers) show significant promise as tools for expanding the apparatus's functionality. On-device translation of subtitles by televisions presents one example of such models' ability to enhance a device's functionality and its users' experience by making content globally available, even if the content was originally subtitled in only a few widely spoken languages.

However, lightweight on-device AI/ML language processing models have shown greater susceptibility to providing erroneous outputs (for example, translation errors) in response to syntactic errors in their input text than deeper, more computationally expensive models which can be implemented on more powerful, dedicated processing devices. Additionally, training models to manage certain syntactic errors, such as end of sentence detection or predicting the ends of sentences has proven challenging, even with more powerful processing devices. For example, training with traditional loss functions such as Binary Cross Entry (BCE), the occurrence of incorrect predictions does not take into account the sparsity of EOS token distribution. Applying distribution-based functions such as Kullback-Leibler divergence, Chi-squared, and focal loss approaches do not consider the position of an incorrectly predicted end of sentence token.

Accordingly, reducing the incidence of syntactic errors in the inputs provided to lightweight, on-device AI/ML language processing models remains a source of technical challenges, and opportunities for improvement in the art.

Certain embodiments according to the present disclosure provide mechanisms for refining the textual inputs to lightweight, on-device AI/ML language processing models by performing one or more of: end-of-sentence detection, end-of-sentence token (for example, period marks) correction, grammatical voice-based data augmentation and inference time token merging.

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, and a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). The processor 120 is able to perform control on at least one of the other components of the electronic device 101 and/or perform an operation or data processing relating to communication or other functions. As described below, the processor 120 can be a lightweight processor suitable for use in a television, smartphone, or other device where design, power, or other considerations call for a lower-power processor. Alternatively, processor 120 can be a multi-core processor suitable for use in a dedicated processing device, and which can be used to train on-device AI/ML language processing models.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may include one or more applications that, utilize one or more AI/ML models to perform on-device language operations, such as translating subtitles or foreign language user inputs. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high-definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, the sensor(s) 180 include cameras or other imaging sensors, which may be used to capture images of scenes. The sensor(s) 180 can also include one or more buttons for touch input, one or more microphones, a depth sensor, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram c (EEG) sensor, an electrocardiogram (ECG) sensor, an infrared (IR) sensor, an ultrasound sensor, an iris sensor, or a fingerprint sensor. Moreover, the sensor(s) 180 can include one or more position sensors, such as an inertial measurement unit that can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the electronic device 101 can be an extended reality (XR) wearable device, such as a headset or smart eyeglasses. In some embodiments, electronic device 101 can be a digital home assistant, smartphone, or television. In other embodiments, the first external electronic device 102 or the second external electronic device 104 can be a device for training and refining one or more lightweight on-device AI/ML language processing models to be loaded onto, and implemented at, electronic device 101. The electronic device 101 can communicate with the electronic device 102 through the communication interface 170. The electronic device 101 can be directly connected with the electronic device 102 to communicate with the electronic device 102 without involving with a separate network.

The first and second external electronic devices 102, 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102, 104 or server 106). Further, according to certain embodiments of this disclosure, when the electronic device 101 should perform some function or service automatically or at a request, the electronic device 101, instead of executing the function or service on its own or additionally, can request another device (such as electronic devices 102, 104 or server 106) to perform at least some functions associated therewith. The other electronic device (such as electronic devices 102, 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described below, the server 106 may perform one or more functions related to training or refining one or more lightweight AI/ML models for on-device processing.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

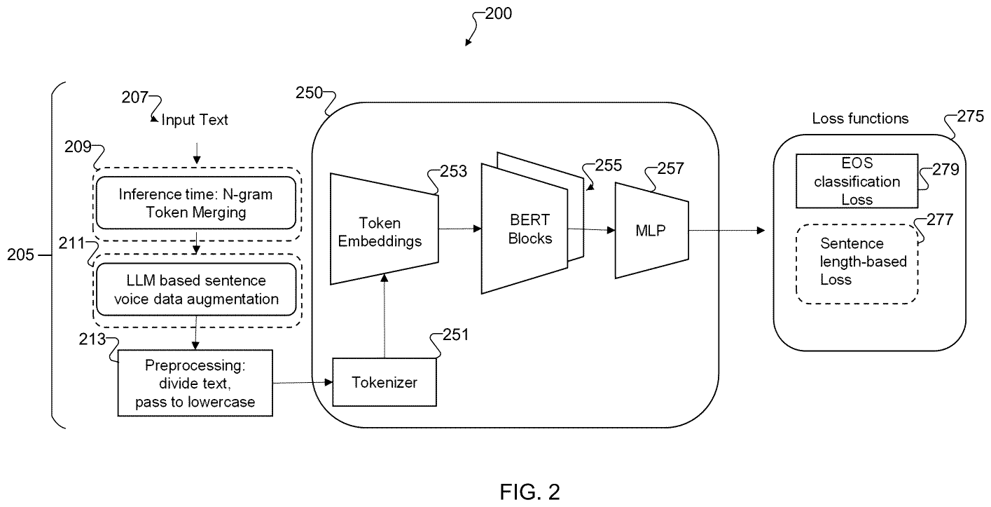

FIG. 2 illustrates an example of a training pipeline 200 for training an end-of-sentence model (EOS) 250 to predict the ends of sentences and correct the EOS token errors of textual inputs to one or more downstream AI/ML models (for example, an on-device translation model).

Referring to the illustrative example of FIG. 2, training pipeline 200 comprises input/preprocessing pipeline 205, EOS model 250, and loss function(s) 275.

As shown in FIG. 2, input/pre-processing pipeline 205 takes textual inputs 207, which can be a stream of text comprising a sequence of sentences. During a training phase, textual inputs 207 comprise training data, for which ground truth values (i.e., where the sentences end, and where EOS tokens, such as periods, question marks and exclamation points) are known. Once trained, textual inputs 207 can be text for which the ground truth values as to the sentences' length and EOS tokens are not known.

As received at input/pre-processing pipeline 205, textual inputs 207 may be provided with syntactic errors, or may be provided at intervals which obscure or hide the ends of sentences or introduce syntactic ambiguities. For example, in a case where textual inputs 207 comprise machine generated on-screen captions for a television program, the on-screen text may be displayed in chunks corresponding to dialog translated over a specified temporal interval. For example, absent clear delineation, the sequence of words “The builder came prepared to assemble the new shed” could, just by splitting the string, be turned into a separate sentence with a different meaning (e.g., “the builder came prepared”) or into a separate sentence and an initial clause of a subsequent sentence (“e.g., “the builder came/prepared to assemble the new shed . . . ”) Even if a stream of text is free of orthographic errors, accurately delimiting sentences is often a prerequisite for accurate subsequent analysis. Input/pre-processing pipeline 205 can, in some embodiments include a token merging stage 209. As discussed in greater detail herein, for certain applications (including, subtitles), a word, or other token to be provided as part of an input to EOS model 250 may be split across two sequences of text. For example, the word “every” may be the terminal word in a text input comprising a first displayed subtitle, and “body” can be the first word in a second text input comprising a second, subsequently displayed subtitle. This scenario presents the issue of whether the tokens “every” and “body” should be merged prior to being passed on as part of an input to EOS model 250. To avoid undue computational expense, and support on-device language processing, certain embodiments according to the present disclosure can perform a statistically-based n-gram inference to predict whether a set of split tokens should be merged.

Input/pre-processing pipeline 205 further comprises an LLM based voice data augmentation stage 211 comprising one or more large language models (LLMs) for data set augmentation. According to some embodiments, one or more LLMs are configured to take textual inputs 207, which have been corrected, if and where necessary by token merging stage 209, for improperly split tokens, and first, determine the grammatical voice (i.e., active voice or passive voice) of the text input 207. Based on the determined grammatical voice, LLM based voice data augmentation stage 211 generates a sentence of predicted equivalent meaning, but in the opposite grammatical voice. As discussed herein, by incorporating one or more LLMs for data set augmentation, bias in the training of EOS model 250 towards due to voice trends in a training set can be reduced, and the training set for EOS model 250 can be expanded.

Input/preprocessing pipeline 205 further comprises a preprocessing stage 213, which normalizes the text in preparation to being provided as an input to EOS model 250. Operations performed at preprocessing stage 213 can include, without limitation, dividing text based on existing EOS tokens (for example, splitting strings of words divided by periods, question marks or exclamation marks), and normalizing text by passing it to lower case.

Following pre-processing at input/pre-processing pipeline 205, sequences of pre-processed text are provided to end-of-sentence model 250. EOS model 250 comprises a neural network which can be trained to predict, based on a textual input, where the end of one or more sentences within the textual input are located. Depending on embodiments, EOS model 250 can also be trained to predict, based on a textual input, one or more appropriate EOS tokens (for example, question marks, exclamation points or periods) to place at the predicted end of the sentence. According to certain embodiments, EOS model 250 is not a closed model, and can be trained from scratch, or can be an existing model (for example, wtp-tiny), which can be refined with additional training data or a modified loss function.

EOS model 250 can, as shown in the figure, be a deep learning model utilizing a transformer architecture, such as shown in the figure. However, other neural network architectures are possible, and within the contemplated scope of this disclosure.

In some embodiments, EOS model 250 can include a tokenizer 251, which converts the received input text into parts (i.e., tokens) which are amenable to machine analysis. Tokens can be individual words, sequences of words, and sequences of words with analytically extraneous words (for example, some articles, transition words) removed.

EOS model 250 can also include an embedding layer, wherein the tokens generated by tokenizer 201 are re-represented (or embedded) as values within an input vector to be transformed across one or more encoding and transformer layers of the neural network, such as bidirectional encoder representations from transformers (“BERT”) blocks 253. Additionally, EOS model 250 can include a multilayer perceptron 257, which can be a feedforward neural network which processes information which the self-attention layer of encoding and transformer layers 255 identify as important.

Notably EOS model 250 outputs, at a minimum, a prediction of the sentence length and/or location of the end of the sentence provided as an input to tokenizer 251.

Loss functions 275 comprise loss functions for which EOS model 250 is trained to iteratively minimize. Loss functions 275 can include a first loss function 277, which, as discussed herein, can be a sentence length-based loss function which can reduce biases within EOS model 250 skewing outputs towards identifying shorter sentences. Loss functions 275 can further include an end-of-sentence classification loss function 279, which scores the error associated with deviations between predicted EOS tokens and ground truth tokens.

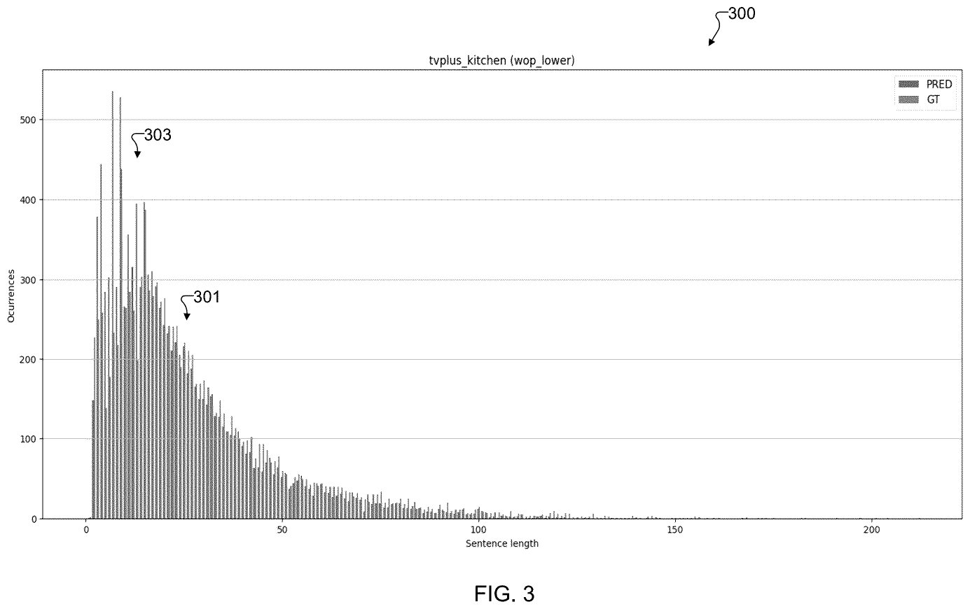

FIG. 3 is a graph 300 showing the differences between ground truth sentence lengths, and the predicted sentence length of a baseline EOS model, which was not trained using a sentence length-based loss function according to this disclosure, and for which no n-gram merging of split tokens was performed, nor was any LLM-based sentence voice data augmentation performed.

Referring to the illustrative example of FIG. 3, two histograms are shown in the figure. A first distribution 301, shown in darker lines, shows the distribution of ground truth sentence lengths in a data set. A second distribution 303, shown in lighter lines, shows the distribution of predicted sentence lengths for the data set as obtained by a baseline EOS model. In this example, the baseline EOS model embodied an architecture comprising a character-level tokenizer configured to identify, and output identified tokens in an input text. The baseline EOS model further comprised a token embedding layer, and one or more BERT layers. The outputs of the BERT layers were passed through a single linear layer, configured to output a binary prediction of whether an end-of-sentence exists after the current character. This baseline EOS model was trained using to minimize one of a plurality of “stock” loss functions known in the art, such as binary cross entropy (BCE).

As shown in the figure, second distribution 303 does not match first distribution 301. Instead, second distribution 303 exhibits a lower mode than first distribution 301, indicating that the baseline EOS model is biased towards identifying shorter sentences. In simpler terms, baseline EOS model's performance is less-than-optimal, in that it incorrectly predicts sentence lengths in a way that skews towards inaccurately, or prematurely, predicting the end of a sentence.

To eliminate bias towards under-prediction of sentence length, certain embodiments according to this disclosure train the EOS model (for example EOS model 250 in FIG. 2) using a sentence length-based loss function, rather than a stock loss function. In some embodiments, the sentence length-based loss function modifies an existing loss function (for example, a BCE loss function) to incorporate a regularization factor which takes into account the position of each character within a given sentence, and applies a penalty based on its distance from an end of sentence marker (for example, a period, question mark or exclamation mark), such that characters closer to the EOS mark receive a smaller penalty than characters further away from an EOS marker.

To avoid penalizing true positives and true negatives, the regularization factor affects incorrect predictions via an XOR mask. In this way, sentence length-based loss functions according to this disclosure ensure that correct predictions are not influenced the regularization factor.

According to certain embodiments, a sentence length-based loss function can be defined as:

$$\begin{matrix}{λ}_{i , j} = \{ \begin{matrix}if {x}_{i , j} \neq {N}_{j} - 1 & \sqrt{{N}_{j} - {x}_{i , j}} \\ else & 0\end{matrix} \\ {\overline{y}}_{i , j} = \{ \begin{matrix}if {\hat{y}}_{i , j} > {y}_{th} & 1 \\ else & 0\end{matrix} \\ {L}_{EOS} ( i , j ) = {L}_{BCE} ( i , j ) = + α * {λ}_{i , j} * XOR ( {y}_{i , j} , {\overline{y}}_{i , j} )\end{matrix}$$

Where j denotes the current sentence, I denotes the current character, Nⱼ denotes the length of the j-th sentence, x_{i,j} denotes the current i-th character's index of the j-th sentence in {0, 1, . . . , Nⱼ−1}, y denotes a ground truth {0,1} regarding the presence of an end of a sentence, ŷ_{i,j} denotes the model's (for example, EOS model 250) end of sentence prediction, yₜₕ denotes a threshold value separating positive and null EOS predictions, BCE denotes a value of a binary cross-entropy loss function, and a is a hyperparameter that multiplies the regularization term, and which can be tuned to reflect the fact that different sources and domains may have distinct average sentence lengths.

As noted with reference to FIG. 2, in addition to biases towards shorter sentences, baseline EOS models can also exhibit biases or skewed error rates in response to the grammatical voice (i.e., passive, or active voice) of the textual input. To mitigate grammatical voice-related biases in the predictions, certain embodiments according to the present disclosure implement (for example, at LLM based voice data augmentation stage 211) LLM-based sentence voice data augmentation.

According to certain embodiments, when a textual input is received during training of an EOS model, embodiments according to the present disclosure can pass the textual input to one or more LLMs (for example, LlaMA 3-70b) to predict the current voice of the input sentence. Based on the prediction, a generative LLM translates the received sentence to the opposite grammatical voice. In linguistic domains (for example, English) where the active voice and passive voice expressions of a sentence are of equivalent length, both formulations of the sentence can be used as training data. In this way, the training of the model is double-reinforced such that the penalty for incorrect EOS predictions during training is doubled.

As noted with reference to FIG. 2, split tokens (for example, turning “someone” into “some” and “one”) can undermine the training of an EOS and introduce prediction errors during inference. For certain applications, including translating machine-generated subtitles from streamed video content, the problem of split tokens can be particular acute, with words being split into sub-words across consecutive lines, or alternatively, words being split across a first set of subtitles, and a second, subsequently displayed set of subtitles.

As shown below, improperly splitting tokens can significantly affect the semantics of a sentence, and, by implication, the accuracy of machine-based translations of the sentence.

TABLE 1

| Example 1 | Example 2 |
|---|---|
| “<line1> He decided to with | <line1> The artist came prepared with |
| <line2> draw all his savings | <line2> drawing tools to sketch the |
| from his bank” | landscape. |

As shown above, Table 1 provides two instances in which the words “with” and “draw[ing]” are split. In the first example, the tokens “with” and “draw” should be merged. However, in the second example, the tokens “with” and “drawing” should not be merged. As skilled artisans will appreciate, incorrectly merging the “with” and “draw” tokens will affect the semantics of the sentence, and their translation.

To solve the problem of determining whether to merge split tokens prior to inference, or where appropriate, prior to their use as training data, in a computationally inexpensive manner suitable for implementation on the lower-power processors of televisions, smartphones or other devices which operate under tighter power, size or design constraints than dedicated processing devices (i.e., laptops or server computers) embodiments according to this disclosure use a computationally inexpensive n-gram approach by which tokens are merged based on a predetermined probability of token merging. Under this approach, a device performing on-device EOS prediction according to this disclosure only needs to consult a look up table (or equivalent data structure) of previously n-grams to obtain a merge probability and compare the merge probability against a threshold value. If the stored probability is below the threshold, then the tokens should be merged. If the stored probability is above the threshold, then the tokens should not be merged. By this approach, much fewer processing and memory resources are used than by implementing a neural network to predict whether tokens should be merged.

For a first set of tokens (p, q, r) and a second set of tokens (s, t, . . . ) the probability of token merging can be calculated from a training set of text (for example, using an N-gram service) to obtain probabilities for expected n-grams. In the example of tokens p-t above, the probability that the tokens r and s should be merged can be computed as follows:

$$p - merge = trigram ( q , r , s ) / bigram ( q , concatenate ( r , s ) )$$

Three examples of computed p-merge values are provided below:
a. “and every one” vs “and everyone”: p-merge=0.000159/0.000684=0.23
b. “taken care of” vs “taken careof”: p-merge=0.000300/0.00000003=10000
c. “to high light” vs “to highlight”: p-merge=0.000001/0.0005=0.002

As shown above, the computed p-merge probabilities shown above correspond to a native English speaker's trained understanding of when tokens should and should not be merged, with the clear error cases “taken careof” having the highest score, and “to high light” having the lowest p-merge score.

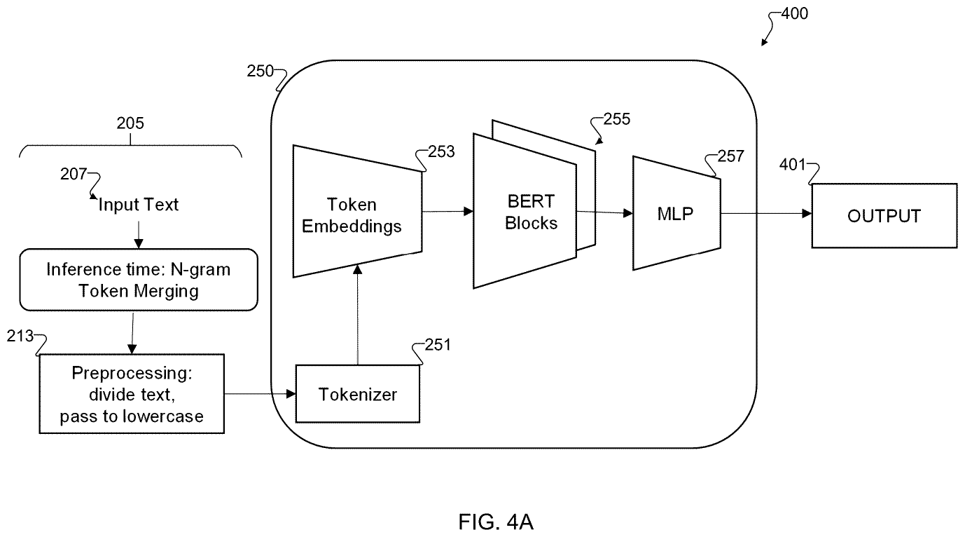

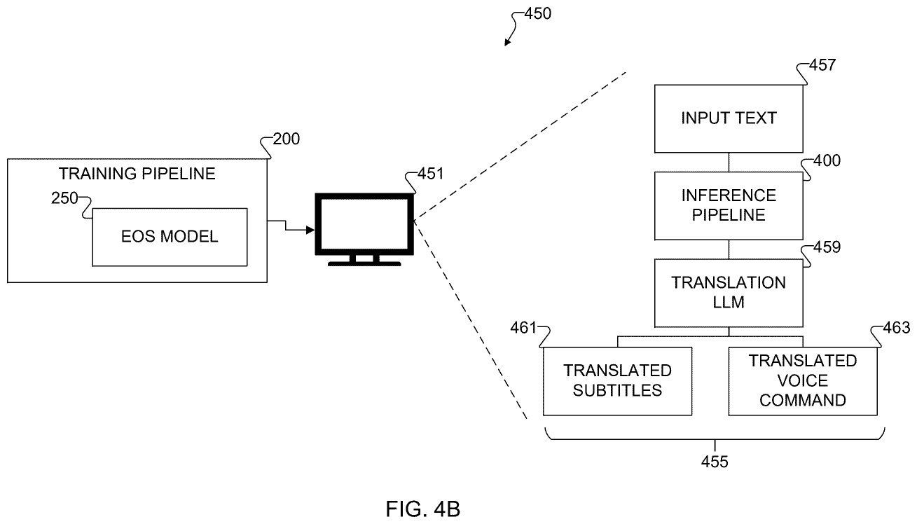

FIGS. 4A and 4B illustrate examples of implementations of an EOS models trained according to the present disclosure and incorporating on-device n-gram based token merge prediction according to this disclosure. For consistency and convenience of cross-reference elements of FIGS. 4A and 4B described elsewhere herein or referenced in more than one of FIGS. 4A and 4B are numbered similarly.

Referring to the illustrative example of FIG. 4A, an example of an EOS inference pipeline 400 according to embodiments of this disclosure. As shown in the figure, EOS inference pipeline 400 can include components of EOS training pipeline 200 described with reference to FIG. 2. As shown in FIG. 4A, EOS inference pipeline receives text input 207, which can be spoken utterances, snippets of written text (for example, lines of closed captioning), and passes them to token merging stage 209. As described herein, in some embodiments, token merging stage 209 can perform computationally lightweight predictions of whether separated tokens should be merged based on previously determined n-gram scores stored in memory. According to some embodiments, EOS inference pipeline 400 also includes preprocessing stage 213, which operates similarly during inference as in training, to normalize the formatting of input text 207. As previously noted, operations performed at preprocessing stage 213 can include, without limitation, dividing text into separate inputs, such as upon detection of periods and other terminal punctuation denoting the end of a sentence. Additionally, operations performed at preprocessing stage 213 can include formatting all of the letters in the textual input as lowercase.

EOS inference pipeline 400 further includes EOS model 250, which is the same model as in training pipeline 200, only now trained using one or more of sentence length-based loss function (for example, sentence length-based loss function 277 in FIG. 2) and a data set which has been augmented to include both passive and active voice instances of sentences in the training set. According to certain embodiments, ESO model 250 receives, as inputs, preformatted text 207, and provides, as outputs, predictions 401 as to the EOS locations within the textual inputs. The EOS predictions 401 may be provided as classifier outputs as to whether the EOS occurs after a particular word in the preformatted input text. Additionally, where EOS tokens are missing in the preformatted input text, EOS outputs 401 can include predictions as to both the location and type of the EOS outputs.

While technically challenging to obtain and, for many applications, a prerequisite to implementing on-device AI/ML language processing models with limited processing power, EOS outputs 401 can, by themselves, be of limited utility. FIG. 4B illustrates one example system 450 in which inference pipeline 400 can be utilized to act as a gate, or active buffer, which meters an undelimited, or imperfectly delimited stream of text into sentence-sized inputs for processing by an on-device LLM. Through accurate sentence detection and consistent delimiting of input text into complete sentences, the accuracy with which an on-device LLM translates the textual inputs can be maximized.

Referring to the illustrative example of FIG. 4B, an EOS model 250 according to embodiments of this disclosure can be trained offline, for example, on a server or cloud computing platform (for example, server 106 in FIG. 1) implementing a training pipeline 200. Once trained, model 250 can be deployed to a device 451 (for example, electronic device 101 in FIG. 1) with comparatively less processing power than that of the computing platform on which model 250 was trained as part of an on-device translation pipeline 455.

As shown in the figure, on-device translation pipeline 455 is configured to receive as its input, one or more streams of text 457. The one or more streams of text 457 can include, without limitation, onscreen subtitles in a first language or voice commands in a first language. The one or more streams of text can be one or more of, unpunctuated, improperly punctuated, or provided in sections of arbitrary length which do not align with the natural syntactic breaks and ends of sentences. Additionally, the one or more streams of text can include improperly split tokens (for example, instances of “when ever” instead of “whenever”).

The one or more streams of text 457 can be provided to inference pipeline 400, which as previously described, can include a input/preprocessing pipeline 205 for predicting and applying predicted corrections to improperly split tokens and an EOS model 250, whose outputs can include predictions as to the location of, and proper EOS tokens for, the ends of sentences contained in the one or more streams of text 457. Using the outputs of inference pipeline, pre-processed text from one or more streams of text 457 can be provided one complete sentence at a time to one or more on-device LLMs (for example, a translation model 459) to obtain machine translations of the individual sentences contained int ch one or more streams of text 457. The outputs of translation model 459 can then be passed to one or more applications executing on device 451, such as an on-device subtitling application 461 or a voice command application 463.

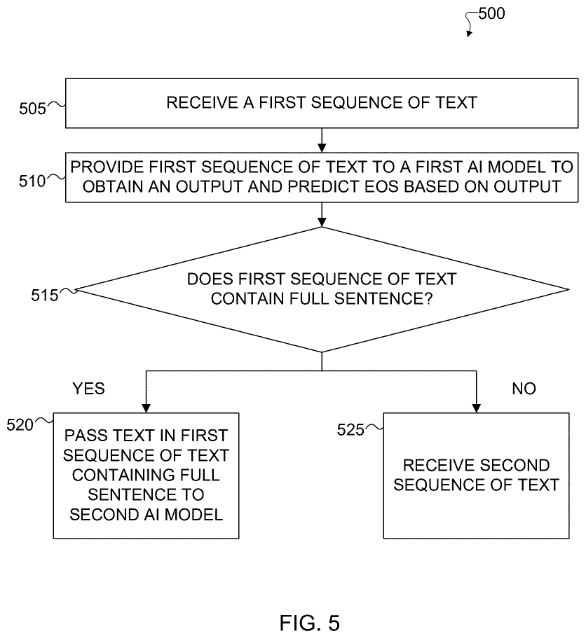

FIG. 5 illustrates operations of an example method 500 for predicting an end of sentence in one or more sequences of text according to this disclosure. The operations described with reference to FIG. 5 can be performed on-device at one or more of a smartphone, television, head mounted display, home digital assistant or other apparatus whose processing power is constrained by power, size, or other design considerations.

Referring to the illustrative example of FIG. 5, at operation 505, an apparatus (for example, device 451 of system 450 in FIG. 4B) receives a first sequence of text (for example, text 457 in FIG. 4B). The first sequence of text can comprise all or part of a sentence and may contain one or more arbitrarily split tokens (for example, compound words such as “withdraw” broken across lines of a displayed set of subtitles). The first sequence of text received at operation 505 can be, without limitation, blocks of machine generated subtitles in a first language, text strings from voice commands in a first language, or text from typed commands in a first language.

At operation 510, the first sequence of text received at operation 505 is passed to a first artificial intelligence model (for example, EOS model 250) to obtain an output, and to perform an end of sentence (EOS) prediction based on the output. In certain embodiments, passing the first sequence of text to the first AI model can also include pre-processing and cleanup of the first sequence of text, such as rejoining incorrectly split tokens (such as by use of n-gram token merging, as described herein) and normalizing the capitalization of the first sequence of text (for example, by converting it to all lower case). To offset biases towards underestimating sentence lengths (for example, as described with reference to FIG. 2 of this disclosure), the first AI model can be trained using a sentence length-based loss function.

At operation 515, the apparatus performs a determination, based on the output of the first AI model whether the first sequence of text contains a compete sentence. As noted elsewhere in this disclosure, for many AI/ML language processing models, receiving incomplete sentence inputs can, even when the model is implemented on a dedicated, powerful processing platform, be a confounding factor and diminish the accuracy of the predicted output. Therefore, it can be desirable to, where possible, pass inputs comprising full sentences to downstream AI/ML language processing models.

At operation 520, responsive to determining that the first sequence of text comprises the complete sentence, the apparatus passes text comprising the determined complete sentence to a second AI language processing model (for example, translation model 459 in FIG. 4B) for further processing.

At operation 525, in response to determining that the first sequence of text does not comprise a complete sentence, the apparatus receives a second sequence of text, and method 500 is returns to operation 510, wherein the first and second sequences of text are provided to the first AI model.

It should be noted that the functions shown in or described with respect to FIGS. 2-5 can be implemented in an electronic device 101, 102, 104, server 106, or other device(s) in any suitable manner. For example, at least some of the functions shown in or described with respect to FIGS. 2 through 7 can be implemented or supported using one or more software applications or other software instructions that are executed by the processor 120 of the electronic device 101, 102, 104, server 106, or other device(s). In other embodiments, at least some of the functions shown in or described with respect to FIGS. 2 through 5 can be implemented or supported using dedicated hardware components. In general, the functions shown in or described with respect to FIGS. 2 through 5 can be performed using any suitable hardware or any suitable combination of hardware and software/firmware instructions. Also, the functions shown in or described with respect to FIGS. 2 through 5 can be performed by a single device or by multiple devices.

Although this disclosure has been described with example embodiments, various changes and modifications may be suggested to one skilled in the art. For example, the range of domains (i.e., languages) in which embodiments according to this disclosure can be practiced is large and can include languages which do not differentiate between active and passive voice (for example, Basque) as well as languages using pictographic tokens that cannot be split. It is intended that this disclosure encompass such changes and modifications as fall within the scope of the appended claims.

What is claimed is:

1. A method, comprising:
receiving a first sequence of text comprising a part of a sentence;
providing the first sequence of text to a first artificial intelligence (AI) model to obtain an output, and predicting an end-of-sentence (EOS) based on the output;
determining, based on the predicted EOS if the first sequence of text comprises a complete sentence;
responsive to determining that the first sequence of text comprises the complete sentence, providing text within the first sequence of text comprising the complete sentence as an input to a second AI model; and
responsive to determining that the first sequence of text does not comprise the complete sentence, receiving a second sequence of text,
wherein the first AI model is optimized based on a sentence length-based loss function.

2. The method of claim 1, further comprising predicting an EOS token for the sentence.

3. The method of claim 1, wherein the first AI model is trained on an LLM augmented data set comprising active and passive voice expressions of equivalent statements.

4. The method of claim 1, further comprising performing an n-gram based token merging to maintain one or more sentence semantics within at least one of the first sequence of text or the second sequence of text.

5. The method of claim 1, wherein:
the first sequence of text is in a first language; and
the output of the second AI model comprises a translation of the complete sentence in a second language generated by an on-device large language model implemented at one of:
a television;
a smartphone;
an extended reality (XR) headset; or
digital home assistant.

6. The method of claim 1, wherein the sentence length-based loss function comprises a regularization factor based on a position of each character within a sequence of text and that applies a penalty for EOS predictions which increases based on a distance of the character from a ground truth value for the EOS.

7. The method of claim 6, wherein the sentence length-based loss function is given by:
$$\begin{matrix}{λ}_{i , j} = \{ \begin{matrix}if {x}_{i , j} \neq {N}_{j} - 1 & \sqrt{{N}_{j} - {x}_{i , j}} \\ else & 0\end{matrix} \\ {\overline{y}}_{i , j} = \{ \begin{matrix}if {\hat{y}}_{i , j} > {y}_{th} & 1 \\ else & 0\end{matrix} \\ {L}_{EOS} ( i , j ) = {L}_{BCE} ( i , j ) = + α * {λ}_{i , j} * XOR ( {y}_{i , j} , {\overline{y}}_{i , j} )\end{matrix}$$
wherein j denotes a current sentence, I denotes a current character, Nⱼ denotes a length of a j-th sentence, x_{i,j} denotes a current i-th character's index of the j-th sentence in {0, 1, . . . , Nⱼ−1}, y denotes a ground truth {0,1} regarding a presence of an end of a sentence, ŷ_{i,j} denotes an end of sentence prediction output by the first AI model, yₜₕ denotes a threshold value separating positive and null EOS predictions, BCE denotes a value of a binary cross-entropy loss function, and a is a hyperparameter multiplying a regularization term.

8. An electronic device, comprising:
a memory; and
at least one processor configured to:
receive a first sequence of text comprising a part of a sentence;
provide the first sequence of text to a first artificial intelligence (AI) model to obtain an output, and predicting an end-of-sentence (EOS) based on the output;
determine, based on the predicted EOS if the first sequence of text comprises a complete sentence;
responsive to determining that the first sequence of text comprises the complete sentence, provide text within the first sequence of text comprising the complete sentence as an input to a second AI model; and
responsive to determining that the first sequence of text does not comprise the complete sentence, receive a second sequence of text,
wherein the first AI model is optimized based on a sentence length-based loss function.

9. The electronic device of claim 8, wherein the at least one processor is further configured to predict an EOS token for the sentence.

10. The electronic device of claim 8, wherein the first AI model is trained on an LLM augmented data set comprising active and passive voice expressions of equivalent statements.

11. The electronic device of claim 8, wherein the at least one processor is further configured to perform an n-gram based token merging to maintain one or more sentence semantics within at least one of the first sequence of text or the second sequence of text.

12. The electronic device of claim 8, wherein:
the first sequence of text is in a first language; and
the output of the second AI model comprises a translation of the complete sentence in a second language generated by an on-device large language model implemented at one of:
a television;
a smartphone;
an extended reality (XR) headset; or
digital home assistant.

13. The electronic device of claim 8, wherein the sentence length-based loss function comprises a regularization factor based on a position of each character within a sequence of text and that applies a penalty for EOS predictions which increases based on a distance of the character from a ground truth value for the EOS.

14. The electronic device of claim 13, wherein the sentence length-based loss function is given by:
$$\begin{matrix}{λ}_{i , j} = \{ \begin{matrix}if {x}_{i , j} \neq {N}_{j} - 1 & \sqrt{{N}_{j} - {x}_{i , j}} \\ else & 0\end{matrix} \\ {\overline{y}}_{i , j} = \{ \begin{matrix}if {\hat{y}}_{i , j} > {y}_{th} & 1 \\ else & 0\end{matrix} \\ {L}_{EOS} ( i , j ) = {L}_{BCE} ( i , j ) = + α * {λ}_{i , j} * XOR ( {y}_{i , j} , {\overline{y}}_{i , j} )\end{matrix}$$
wherein j denotes a current sentence, I denotes a current character, Nⱼ denotes a length of a j-th sentence, x_{i,j} denotes a current i-th character's index of the j-th sentence in {0, 1, . . . , Nⱼ−1}, y denotes a ground truth {0,1} regarding a presence of an end of a sentence, ŷ_{i,j} denotes an end of sentence prediction output by the first AI model, yₜₕ denotes a threshold value separating positive and null EOS predictions, BCE denotes a value of a binary cross-entropy loss function, and a is a hyperparameter multiplying a regularization term.

15. A non-transitory computer-readable medium including instructions, which, when executed by at least one processor, cause an electronic device to:
receive a first sequence of text comprising a part of a sentence;
provide the first sequence of text to a first artificial intelligence (AI) model to obtain an output, and predicting an end-of-sentence (EOS) based on the output;
determine, based on the predicted EOS if the first sequence of text comprises a complete sentence;
responsive to determining that the first sequence of text comprises the complete sentence, provide text within the first sequence of text comprising the complete sentence as an input to a second AI model; and
responsive to determining that the first sequence of text does not comprise the complete sentence, receive a second sequence of text,
wherein the first AI model is optimized based on a sentence length-based loss function.

16. The non-transitory computer-readable medium of claim 15, further comprising instructions, which, when executed, cause the electronic device to predict an EOS token for the sentence.

17. The non-transitory computer-readable medium of claim 15, wherein the first AI model is trained on an LLM augmented data set comprising active and passive voice expressions of equivalent statements.

18. The non-transitory computer-readable medium of claim 15, further comprising instructions, that when executed, cause an electronic device to perform an n-gram based token merging to maintain one or more sentence semantics within at least one of: the first sequence of text or the second sequence of text.

19. The non-transitory computer-readable medium of claim 15, wherein:
the first sequence of text is in a first language; and
the output of the second AI model comprises a translation of the complete sentence in a second language generated by an on-device large language model implemented at one of:
a television;
a smartphone;
an extended reality (XR) headset; or
digital home assistant.

20. The non-transitory computer-readable medium of claim 15, wherein the sentence length-based loss function comprises a regularization factor based on a position of each character within a sequence of text and that applies a penalty for EOS predictions which increases based on a distance of the character from a ground truth value for the EOS.
